(19) United States
(12) Patent Application Publication
(10) Pub. No.: US 2023/0252474 A1
(43) Pub. Date: Aug. 10, 2023

(54) WARNING DEVICE, WARNING SYSTEM, WARNING METHOD, AND NON-TRANSITORY COMPUTER-READABLE MEDIUM STORING WARNING PROGRAM

(71) Applicant: NEC Corporation, Minato-ku, Tokyo (JP)

(72) Inventor: Nobuaki KAWASE, Tokyo (JP)

(73) Assignee: NEC Corporation, Minato-ku, Tokyo (JP)

(21) Appl. No.: 18/012,765

(22) PCT Filed: Jul. 2, 2020
(86) PCT No.: PCT/JP2020/025951

§ 371 Date: Dec. 23, 2022

(51) Int. Cl. G06Q 20/40; G06Q 20/18; G06Q 30/0601; G06V 40/16

(52) U.S. Cl. CPC G06Q 20/40145; G06Q 20/18; G06Q 30/0625; G06V 40/171

(57) ABSTRACT

A warning device (100) includes: a biometric information acquisition unit (112) that acquires biometric information included in a captured image captured by a predetermined imaging device; an authentication request unit (114) that causes an authentication device (200) that stores biometric information of a plurality of users to perform personal authentication for the acquired biometric information; an attribute information acquisition unit (115) that acquires attribute information of a user who has succeeded in the personal authentication in a case where the personal authentication has succeeded; a substance information acquisition unit (116) that acquires substance information included in a product selected by the user; a determination unit (117) that determines whether or not the substance information corresponds to the attribute information; and an output unit (118) that outputs warning information to a predetermined display terminal in a case where the substance information corresponds to the attribute information.

### TECHNICAL FIELD

The present invention relates to a warning device, a warning system, a warning method, and a non-transitory computer-readable medium storing a warning program, and more particularly, to a warning device, a warning system, a warning method, and a non-transitory computer-readable medium storing a warning program for providing warning information to a user.

### BACKGROUND ART

Patent Literature 1 discloses a technology of determining that a person is a registered person by face authentication and outputting information regarding the registered person (for example, allergy).

### CITATION LIST

### Patent Literature

### Patent Literature 1: Japanese Unexamined Patent Application Publication No. 2017-224050

### SUMMARY OF INVENTION

### Technical Problem

There is a demand for knowing whether an allergy-causing substance for a corresponding user is included in a product that the user intends to purchase. However, in the technology according to Patent Literature 1, since the substance included in the product is not collated with allergy information of the user, the user cannot be provided with allergy information included in the product. That is, there is a problem that allergy information of a product selected by a user cannot be provided.

The present disclosure has been made to solve such a problem, and an object of the present disclosure is to provide a warning device, a warning system, a warning method, and a non-transitory computer-readable medium storing a warning program for providing warning information associated to a product selected by a user.

### Solution to Problem

A warning device according to the present disclosure includes: biometric information acquisition means for acquiring biometric information included in a captured image captured by a predetermined imaging device; authentication request means for causing an authentication device that stores biometric information of a plurality of users to perform personal authentication for the acquired biometric information; attribute information acquisition means for acquiring attribute information of a user who has succeeded in the personal authentication in a case where the personal authentication has succeeded; substance information acquisition means for acquiring substance information included in a product selected by the user; determination means for determining whether or not the substance information corresponds to the attribute information; and output means for outputting warning information to a predetermined display terminal in a case where the substance information corresponds to the attribute information.

A warning system according to the present disclosure includes: an imaging device that captures an image including biometric information of a predetermined user; a warning device that is communicable with the imaging device; and an authentication device that stores the biometric information of the user and is communicable with the warning device, in which the warning device includes: biometric information acquisition means for acquiring biometric information included in a captured image captured by the imaging device; authentication request means for causing the authentication device to perform personal authentication for the acquired biometric information; attribute information acquisition means for acquiring attribute information of a user who has succeeded in the personal authentication in a case where the personal authentication has succeeded; substance information acquisition means for acquiring substance information included in a product selected by the user; determination means for determining whether or not the substance information corresponds to the attribute information; and output means for outputting warning information to a predetermined display terminal in a case where the substance information corresponds to the attribute information.

A warning method according to the present disclosure performed by a computer includes: acquiring biometric information included in a captured image captured by a predetermined imaging device; causing an authentication device that stores biometric information of a plurality of users to perform personal authentication for the acquired biometric information; acquiring attribute information of a user who has succeeded in the personal authentication in a case where the personal authentication has succeeded; acquiring substance information included in a product selected by the user; determining whether or not the substance information corresponds to the attribute information; and outputting warning information to a predetermined display terminal in a case where the substance information corresponds to the attribute information.

A non-transitory computer-readable medium according to the present disclosure records a program for performing: acquiring biometric information included in a captured image captured by a predetermined imaging device; causing an authentication device that stores biometric information of a plurality of users to perform personal authentication for the acquired biometric information; acquiring attribute information of a user who has succeeded in the personal authentication in a case where the personal authentication has succeeded; acquiring substance information included in a product selected by the user; determining whether or not the substance information corresponds to the attribute information; and outputting warning information to a predetermined display terminal in a case where the substance information corresponds to the attribute information.

A warning device according to the present disclosure includes: biometric information acquisition means for acquiring biometric information included in a captured image captured by a predetermined imaging device; personal authentication means for performing personal authentication by using biometric information of a plurality of users stored in advance for the acquired biometric information; attribute information acquisition means for acquiring attribute information of a user who has succeeded in the personal authentication in a case where the personal authentication has succeeded; substance information acquisition means for acquiring substance information included in a product selected by the user; determination means for determining whether or not the substance information corresponds to the attribute information; and output means for outputting warning information to a predetermined display terminal in a case where the substance information corresponds to the attribute information.

A warning method according to the present disclosure performed by a computer includes: acquiring biometric information included in a captured image captured by a predetermined imaging device; performing personal authentication by using biometric information of a plurality of users stored in advance for the acquired biometric information; acquiring attribute information of a user who has succeeded in the personal authentication in a case where the personal authentication has succeeded; acquiring substance information included in a product selected by the user;

determining whether or not the substance information corresponds to the attribute information; and outputting warning information to a predetermined display terminal in a case where the substance information corresponds to the attribute information.

A non-transitory computer-readable medium according to the present disclosure records a warning program that causes a computer to perform: acquiring biometric information included in a captured image captured by a predetermined imaging device; performing personal authentication by using biometric information of a plurality of users stored in advance for the acquired biometric information; acquiring attribute information of a user who has succeeded in the personal authentication in a case where the personal authentication has succeeded; acquiring substance information included in a product selected by the user; determining whether or not the substance information corresponds to the attribute information; and outputting warning information to a predetermined display terminal in a case where the substance information corresponds to the attribute information.

### Advantageous Effects of Invention

According to the present disclosure, it is possible to provide the warning device, the warning system, the warning method, and the non-transitory computer-readable medium storing the warning program for providing warning information associated to a product selected by a user.

### BRIEF DESCRIPTION OF DRAWINGS

FIG. 1 is a block diagram illustrating a configuration of a warning device according to a first example embodiment.

FIG. 2 is a flowchart illustrating a flow of a warning method according to the first example embodiment.

FIG. 3 is a block diagram illustrating a configuration of a warning device according to a second example embodiment.

FIG. 4 is a flowchart illustrating a flow of a warning method according to the second example embodiment.

FIG. 5 is a block diagram illustrating a configuration of a warning system according to a third example embodiment.

FIG. 6 is a block diagram illustrating a configuration of an authentication device.

FIG. 7 is a flowchart illustrating a flow of biometric information registration processing.

FIG. 8 is a flowchart illustrating a flow of personal authentication processing.

FIG. 9 is a block diagram illustrating a configuration of a service terminal.

FIG. 10 is a block diagram illustrating a configuration of a service providing device.

FIG. 11 is a flowchart illustrating a flow of user registration processing.

FIG. 12 is a flowchart illustrating a flow of service user ID generation processing.

FIG. 13 is a sequence chart illustrating a flow of warning processing.

FIG. 14 is a block diagram illustrating a configuration of a warning system according to a fourth example embodiment.

FIG. 15 is a block diagram illustrating a configuration of a service providing device.

FIG. 16 is a sequence chart illustrating a flow of warning processing.

FIG. 17 is a block diagram illustrating a configuration of a warning system according to a fifth example embodiment.

FIG. 18 is a block diagram illustrating a configuration of a service providing device.

FIG. 19 is a flowchart illustrating a flow of warning processing.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

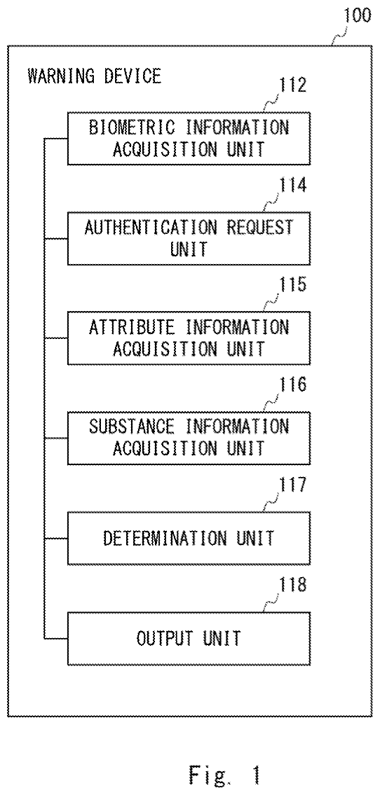

FIG. 1 is a block diagram illustrating a configuration of a warning device 100 according to a first example embodiment. The warning device 100 includes a biometric information acquisition unit 112, an authentication request unit 114, an attribute information acquisition unit 115, a substance information acquisition unit 116, a determination unit 117, and an output unit 118. The warning device 100 is connected to a network 500 (not illustrated). The network 500 may be a wired network or a wireless network. An authentication device 200, a service terminal 300, and the like (not illustrated) are connected to the network 500.

The biometric information acquisition unit 112 acquires biometric information included in a captured image captured by a predetermined imaging device. The imaging device is, for example, the service terminal 300, a camera, or the like. The service terminal 300 is, for example, a communication terminal such as a tablet terminal. The authentication request unit 114 causes the authentication device 200 that stores biometric information of a plurality of users to perform personal authentication for the acquired biometric information. In a case where the personal authentication has succeeded, the attribute information acquisition unit 115 acquires attribute information of a user who has succeeded in the personal authentication. The substance information acquisition unit 116 acquires substance information included in a product selected by the user. The determination unit 117 determines whether or not the substance information corresponds to the attribute information. In a case where the substance information corresponds to the attribute information, the output unit 118 outputs warning information to a predetermined display terminal. The display terminal is, for example, the service terminal 300 or the like.

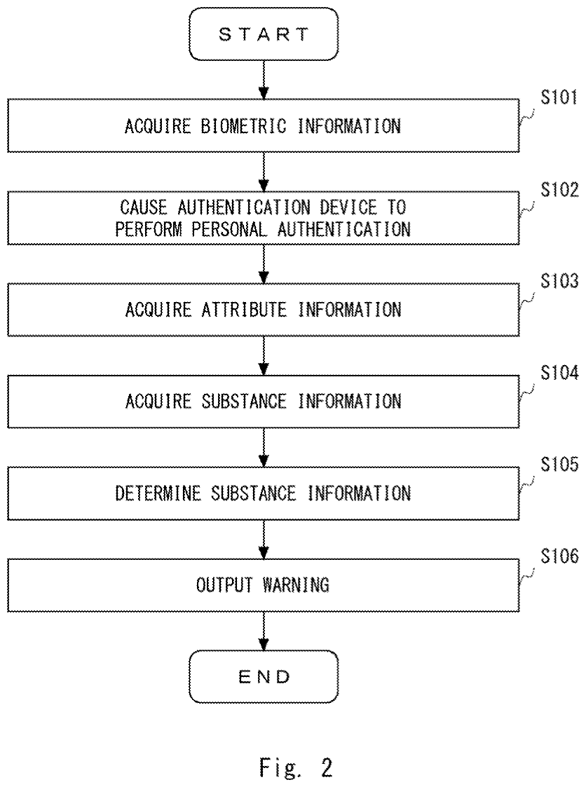

FIG. 2 is a flowchart illustrating a flow of a warning method according to the first example embodiment. First, the biometric information acquisition unit 112 acquires biometric information included in a captured image captured by a predetermined imaging device (step S101). Next, the authentication request unit 114 causes the authentication device 200 that stores biometric information of a plurality of users to perform personal authentication for the acquired biometric information (step S102). The authentication device 200 stores user IDs of a plurality of users and biometric information of each user in association with each other in advance. Once a personal authentication request is received from the warning device 100, the authentication device 200 collates the biometric information included in the captured image with the biometric information stored in the authentication device 200, and performs the personal authentication by determining whether or not the personal authentication has succeeded based on whether or not the pieces of biometric information match each other. In a case where the personal authentication has succeeded, the authentication device 200 includes, in the determination result, a user ID for which the personal authentication has succeeded, and transmits the determination result as a response to the warning device 100.

In a case where the personal authentication has succeeded, the attribute information acquisition unit 115 acquires attribute information of a user who has succeeded in the personal authentication (step S103). Next, the substance information acquisition unit 116 acquires substance information included in a product selected by the user (step S104). Next, the determination unit 117 determines whether or not the acquired substance information corresponds to the attribute information of the user (step S105). In a case where the substance information corresponds to the attribute information, the output unit 118 outputs warning information to a predetermined display terminal (step S106). As described above, since the warning method according to the present example embodiment collates the substance information included in the product selected by the user with the attribute information of the user, it is possible to present warning information associated to the product selected by the user.

Note that the warning device 100 includes a processor, a memory, and a storage device as components not illustrated. Furthermore, the storage device stores a computer program in which processing of the warning method according to the present example embodiment is implemented. Then, the processor reads the computer program from the storage device into the memory, and executes the computer program. As a result, the processor implements the functions of the biometric information acquisition unit 112, the authentication request unit 114, the attribute information acquisition unit 115, the substance information acquisition unit 116, the determination unit 117, and the output unit 118.

Alternatively, each of the biometric information acquisition unit 112, the authentication request unit 114, the attribute information acquisition unit 115, the substance information acquisition unit 116, the determination unit 117, and the output unit 118 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the warning device 100 are implemented by a plurality of information processing devices, circuits, and the like, the plurality of information processing devices, circuits, and the like may be arranged in a centralized manner or in a distributed manner. For example, the information processing devices, the circuits, and the like may be implemented in a form in which each of them is connected via a communication network, such as a client server system or a cloud computing system. Furthermore, the function of the warning device 100 may be provided in a software as a service (SaaS) format.

### Second Example Embodiment

A second example embodiment is a modification of the first example embodiment described above. The warning device 100 according to the first example embodiment performs personal authentication by using the external authentication device 200. On the other hand, a warning device 600 according to the present example embodiment performs personal authentication inside the warning device 600.

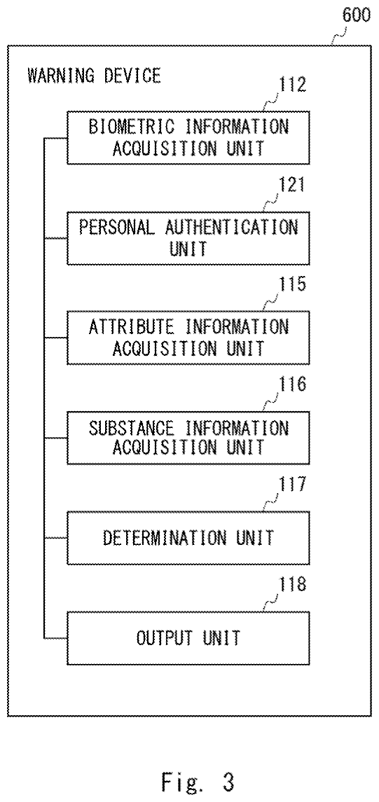

FIG. 3 is a block diagram illustrating a configuration of the warning device 600 according to the second example embodiment. The warning device 600 is different from the warning device 100 illustrated in FIG. 1 in that the authentication request unit 114 is replaced with a personal authentication unit 121, and an authentication database (DB) (not illustrated) is added. The authentication DB is information in which biometric information of a user is associated with a user ID of the user. For each component included in the warning device 600, a description overlapping with that of the first example embodiment will be omitted as appropriate.

The personal authentication unit 121 performs personal authentication by using biometric information of a plurality of users stored in advance for the acquired biometric information. In personal authentication, the personal authentication unit 121 collates biometric information included in a captured image with biometric information stored in the authentication DB, and determines whether or not the personal authentication has succeeded based on whether or not the pieces of biometric information match each other. The authentication DB stores biometric information of a plurality of registered users. The personal authentication unit 121 transmits success or failure of the personal authentication to the attribute information acquisition unit 115.

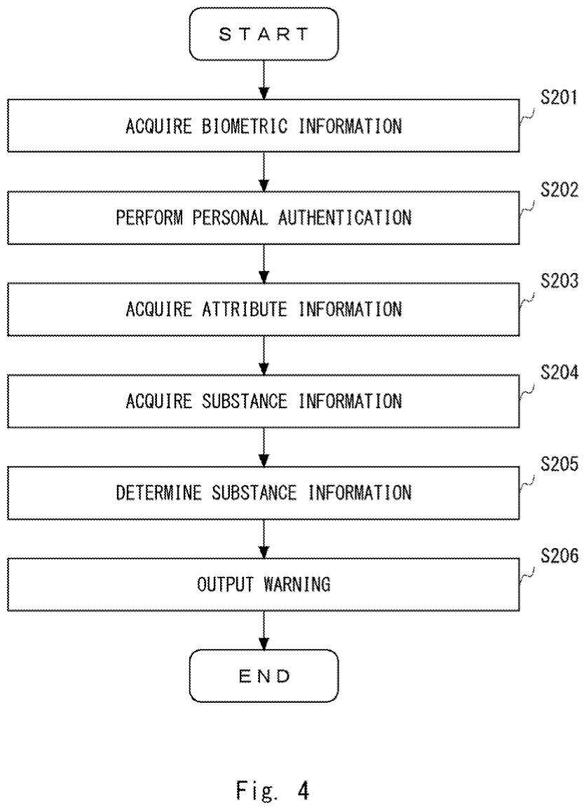

FIG. 4 is a flowchart illustrating a flow of a warning method according to the second example embodiment. First, the biometric information acquisition unit 112 acquires biometric information included in a captured image captured by a predetermined imaging device (step S201). Next, the personal authentication unit 121 performs personal authentication by using biometric information of a plurality of users stored in advance for the acquired biometric information (step S202). The authentication DB stores user IDs of a plurality of users and biometric information of each user in association with each other in advance.

In a case where the personal authentication has succeeded, the attribute information acquisition unit 115 acquires attribute information of a user who has succeeded in the personal authentication (step S203). Next, the substance information acquisition unit 116 acquires substance information included in a product selected by the user (step S204). Next, the determination unit 117 determines whether or not the acquired substance information corresponds to the attribute information of the user (step S205). In a case where the substance information corresponds to the attribute information, the output unit 118 outputs warning information to a predetermined display terminal (step S206). The warning device according to the present example embodiment can achieve effects similar to the effects described in the first example embodiment.

### Third Example Embodiment

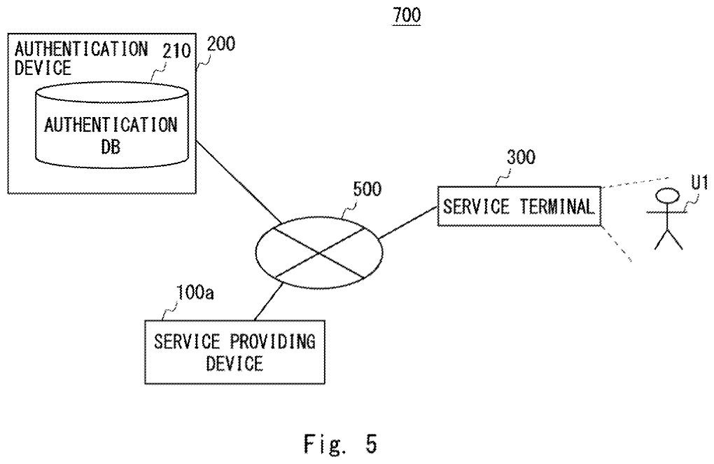

A third example embodiment is a specific example of the first example embodiment described above. FIG. 5 is a block diagram illustrating a configuration of a warning system 700 according to the third example embodiment. The warning system 700 includes a service providing device 100a, an authentication device 200, and a service terminal 300. Each of the service providing device 100a, the authentication device 200, and the service terminal 300 is connected via a network 500. Note that a description overlapping with the first example embodiment will be omitted as appropriate.

The service providing device 100a is an example of the warning device. The service providing device 100a is an information processing device that performs personal authentication for biometric information included in a captured image, selects warning information based on attribute information of a user who has succeeded in the personal authentication and substance information included in a product selected by the user in a case where the personal authentication has succeeded, and outputs the selected warning information. The service providing device 100a is, for example, a server device implemented by a computer. The authentication device 200 is a device that performs biometric authentication. The biometric authentication is personal authentication based on biometric information. The authentication device 200 includes an authentication DB 210. The authentication DB 210 is a database that stores biometric information and the like for each user. The service terminal 300 is an information processing device that captures an image including biometric information of a user who intends to purchase a product at a store, transmits a personal authentication request including the biometric information to the service providing device 100a, and receives and displays warning information in a case where the personal authentication has succeeded. The service terminal 300 is installed in the store. Hereinafter, it is assumed that a user U1 visits the store as illustrated in FIG. 5.

The service providing device 100a and the service terminal 300 are devices constituting a system for a service provider to provide a service such as selling a product to a user. Therefore, the authentication device 200 can be said to be a server that operates as an authentication station of a service provider. According to the present example embodiment, the authentication device 200 operates as an authentication station of a plurality of service providers.

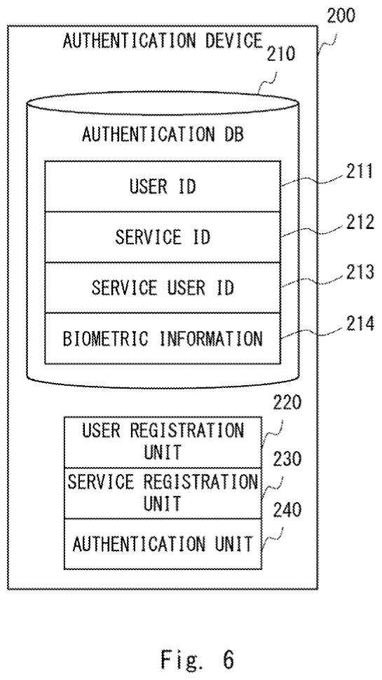

A configuration of the authentication device 200 will be described in detail with reference to FIG. 6. FIG. 6 is a block diagram illustrating the configuration of the authentication device 200. The authentication device 200 includes the authentication DB 210, a user registration unit 220, a service registration unit 230, and an authentication unit 240.

The authentication DB 210 is information in which a service user ID 213 of a corresponding user and biometric information 214 of the user are associated with a user ID 211. The authentication DB 210 further stores a service ID 212. Therefore, the authentication DB 210 can be said to be a database that stores the user ID 211, the service ID 212, the service user ID 213, and the biometric information 214 in association with each other. Here, the service ID 212 is an ID for identifying a service provider. The service user ID 213 is an ID for identifying a user who uses the service. The biometric information 214 is information for identifying a user. The biometric information 214 is, for example, face feature information, a fingerprint, or the like. The face feature information is a set of feature points extracted from a captured image of a face region.

The user registration unit 220 registers the biometric information 214 included in the captured image in the authentication DB 210. The user registration unit 220 newly issues the user ID 211 when registering the biometric information 214. The user registration unit 220 registers the issued user ID 211 and the biometric information 214 included in the captured image in the authentication DB 210 in association with each other.

The service providing device 100a transmits a user registration request including a user ID and a service ID to the authentication device 200. The service registration unit 230 registers the service ID 212 included in the received user registration request in the authentication DB 210. Once the user registration request is received from the service providing device 100a, the service registration unit 230 newly issues the service user ID 213. The service registration unit 230 registers the issued service user ID 213 in the authentication DB 210 in association with the user ID 211 included in the user registration request.

The authentication unit 240 collates biometric information extracted from a captured image with biometric information in the authentication DB 210. The authentication unit 240 determines that the personal authentication has succeeded in a case where the pieces of biometric information match each other, and determines that the personal authentication has failed in a case where the pieces of biometric information do not match each other. The authentication unit 240 transmits success or failure of the personal authentication as a response to the service providing device 100a. Whether or not the pieces of biometric information match each other corresponds to the success or failure of the personal authentication. In addition, in a case where the personal authentication has succeeded, the authentication unit 240 specifies a user ID associated with the biometric information for which the personal authentication has succeeded, and transmits an authentication result including the specified user ID and indicating that the personal authentication has succeeded to the service providing device 100a.

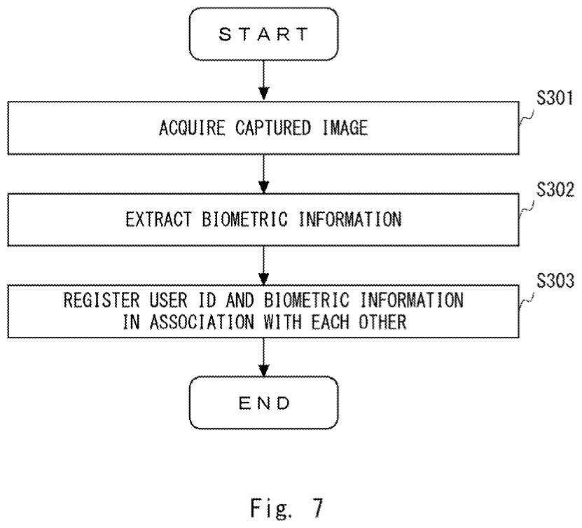

An operation of the authentication device 200 when registering a user ID and biometric information in the authentication DB 210 will be described with reference to FIG. 7. FIG. 7 is a flowchart illustrating a flow of biometric information registration processing.

When registering biometric information, an information registration terminal (not illustrated) captures an image including biometric information of a user, and transmits a biometric information registration request to the authentication device 200 via the network 500. The captured image including the biometric information is, for example, an image including a face region or a fingerprint image. The information registration terminal is, for example, an information processing device such as a personal computer, a smartphone, or a tablet terminal. The information registration terminal is, for example, a communication terminal owned by the user. The biometric information registration request includes the captured image. First, the authentication device 200 acquires the captured image included in the biometric information registration request from the information registration terminal via the network 500 (step S301).

Next, the user registration unit 220 extracts the biometric information included in the captured image (step S302), issues a user ID corresponding to the extracted biometric information, and registers the user ID and the biometric information in the authentication DB 210 in association with each other (step S303).

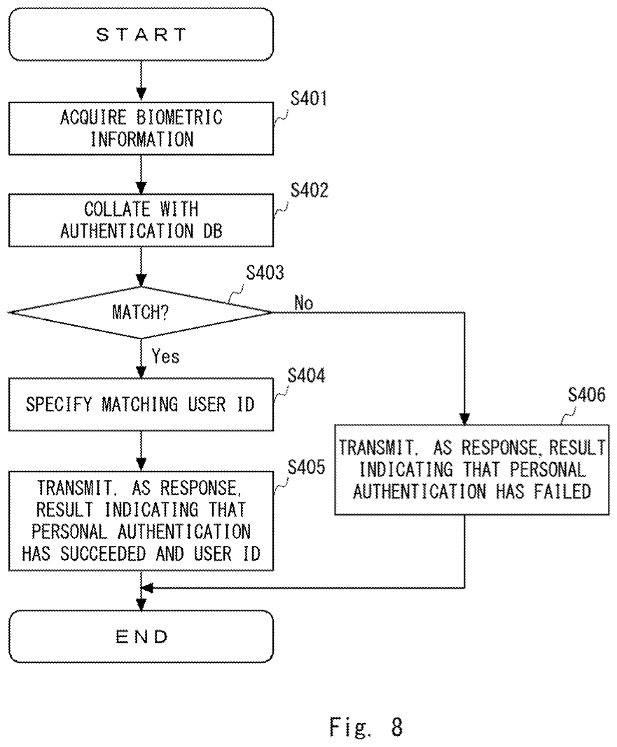

An operation of the authentication device 200 when performing personal authentication will be described with reference to FIG. 8. FIG. 8 is a flowchart illustrating a flow of personal authentication processing. When performing personal authentication, the service terminal 300 captures an image including biometric information of a user, and makes a personal authentication request to the service providing device 100a via the network 500. The personal authentication request includes the captured image. First, the service providing device 100a transmits the captured image or the biometric information extracted from the captured image to the authentication device 200. The authentication unit 240 acquires the biometric information by extracting the biometric information from the received captured image or receiving the biometric information (step S401).

Next, the authentication unit 240 collates the acquired biometric information with biometric information in the authentication DB 210 (step S402). In a case where the pieces of biometric information match each other (Yes in step S403), the authentication unit 240 specifies a user ID of the user whose biometric information matches (step S404), and transmits, as a response, a result indicating that the personal authentication has succeeded and the specified user ID to the service providing device 100a (step S405). In a case where there is no matching biometric information (No in step S403), the authentication unit 240 transmits, as a response, a result indicating that the personal authentication has failed to the service providing device 100a (step S406).

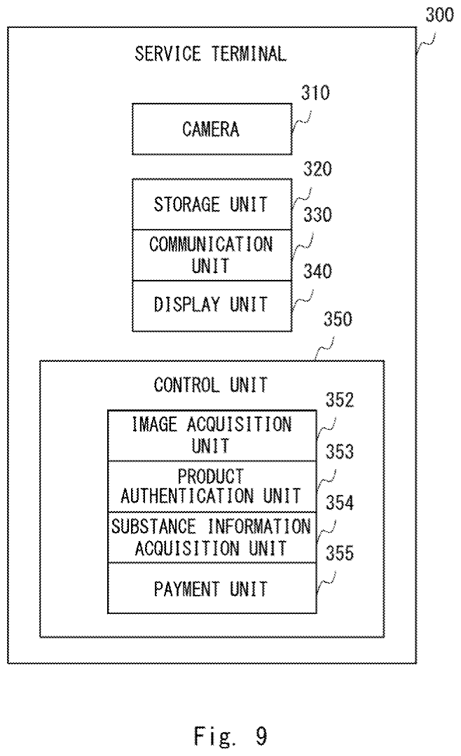

Next, a configuration of the service terminal 300 will be described in detail with reference to FIG. 9. The service terminal 300 includes an imaging device such as a camera, a display terminal, and a computer as hardware components. The service terminal 300 is a device that makes a request for personal authentication by biometric authentication. Examples of the service terminal 300 include, but are not limited to, a terminal that performs payment by biometric authentication, a digital signage that presents information according to biometric authentication, and the like.

FIG. 9 is a block diagram illustrating a configuration of the service terminal 300. The service terminal 300 includes a camera 310, a storage unit 320, a communication unit 330, a display unit 340, and a control unit 350. The camera 310 is an imaging device that captures an image. The storage unit 320 is a storage device that stores a program for implementing each function of the service terminal 300. The communication unit 330 is a communication interface with the network 500. The display unit 340 is a display terminal that displays a personal authentication result, warning information, and the like to a user. The control unit 350 controls hardware included in the service terminal 300. The control unit 350 includes an image acquisition unit 352, a product authentication unit 353, a substance information acquisition unit 354, and a payment unit 355.

The image acquisition unit 352 transmits an imaging request to the camera 310. The camera 310 captures an image including a user's face region, a fingerprint, or the like. The image captured by the camera 310 is used at the time of personal authentication or the like. The image acquisition unit 352 transmits a personal authentication request including the captured image to the service providing device 100a. The product authentication unit 353 performs authentication for a product selected by the user. The substance information acquisition unit 354 acquires substance information included in the authenticated product. The substance information is, for example, raw material information of the product or manufacturing information of the product. It is assumed that the service terminal 300 includes a substance information DB (not illustrated). The substance information DB is information in which substance information of a product is associated with the product. The substance information acquisition unit 354 collates an authenticated product with a product registered in the substance information DB, and acquires substance information of a matching product from the substance information DB. The payment unit 355 performs payment processing for an authenticated product. The service terminal 300 is, for example, a point of sales (POS) terminal. In this case, a product reading unit 353 performs authentication for a product by reading a barcode, an image, or the like. The substance information acquisition unit 354 specifies substance information included in the authenticated product by referring to the substance information DB in the service terminal 300 for the product.

The service terminal 300 may operate as the information registration terminal. In this case, the service terminal 300 further includes a biometric information registration unit (not illustrated), and have a function of making a biometric information registration request. When making a biometric information registration request, first, the image acquisition unit 352 controls the camera 310 to capture an image including biometric information of a user. Next, the biometric information registration unit transmits a biometric information registration request including the captured image to the authentication device 200 via the network 500. Finally, the biometric information registration unit receives the registration result from the authentication device 200. Note that the biometric information registration unit may transmit a biometric information registration request including the biometric information extracted from the captured image to the authentication device 200.

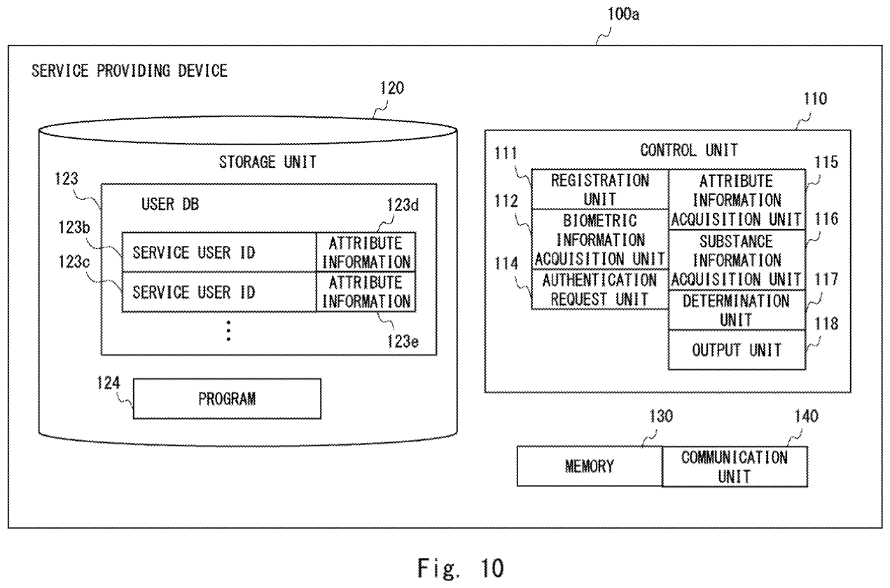

Next, a configuration of the service providing device 100a will be described in detail with reference to FIG. 10. FIG. 10 is a block diagram illustrating a configuration of the service providing device 100a. The service providing device 100a includes a control unit 110, a storage unit 120, a memory 130, and a communication unit 140.

The storage unit 120 is a storage device that stores a user DB 123 and a program 124. The user DB 123 is information in which attribute information of a user is associated with a service user ID. Service user IDs 123b and 123c are identification information that enables identification of a user who uses a service provided by a service provider, and are, for example, a name, a telephone number, an e-mail address, an arbitrary identification number, or the like. The user IDs 123b and 123c are associated with pieces of attribute information 123d and 123e, respectively. The pieces of attribute information 123d and 123e are information necessary for a service provider to provide a service to a user, and is, for example, allergy information for the user or information on food that the user cannot eat. The program 124 is a computer program in which the warning processing according to the present example embodiment is implemented.

The memory 130 is a storage region for temporarily storing processing contents of the control unit 110, and is, for example, a volatile storage device such as a random access memory (RAM). The communication unit 140 is an interface that communicates with the outside of the service providing device 100a.

The control unit 110 includes a registration unit 111, a biometric information acquisition unit 112, an authentication request unit 114, an attribute information acquisition unit 115, a substance information acquisition unit 116, a determination unit 117, and an output unit 118. The control unit 110 is a control device that controls the operation of the service providing device 100a, and is, for example, a processor such as a CPU. The control unit 110 reads the program 124 from the storage unit 120 into the memory 130 and executes the program 124.

As a result, the control unit 110 implements the functions as the registration unit 111, the biometric information acquisition unit 112, the authentication request unit 114, the attribute information acquisition unit 115, the substance information acquisition unit 116, the determination unit 117, and the output unit 118.

The registration unit 111 receives an attribute information registration request from the service terminal 300 via the network 500. The attribute information registration request includes a service user ID and attribute information of a corresponding user. The registration unit 111 registers the received attribute information in the user DB 123 in association with the service user ID included in the received attribute information registration request. Note that the attribute information registration processing is not limited thereto.

The biometric information acquisition unit 112 receives a captured image from an imaging device such as the service terminal 300 and extracts biometric information from the captured image. The biometric information acquisition unit 112 may also receive biometric information extracted from the captured image. When biometric information is acquired, the authentication request unit 114 causes the authentication device 200 to perform personal authentication on the acquired biometric information. In a case where the personal authentication has succeeded, the attribute information acquisition unit 115 acquires attribute information corresponding to a service user ID of the corresponding user from the user DB.

The substance information acquisition unit 116 acquires substance information by receiving the substance information from the service terminal 300. The determination unit 117 collates the acquired substance information with the attribute information associated with the service user ID, and determines that the substance information corresponds to the attribute information in a case where there is matching substance information. In a case where the substance information corresponds to the attribute information, the output unit 118 outputs warning information to the service terminal 300.

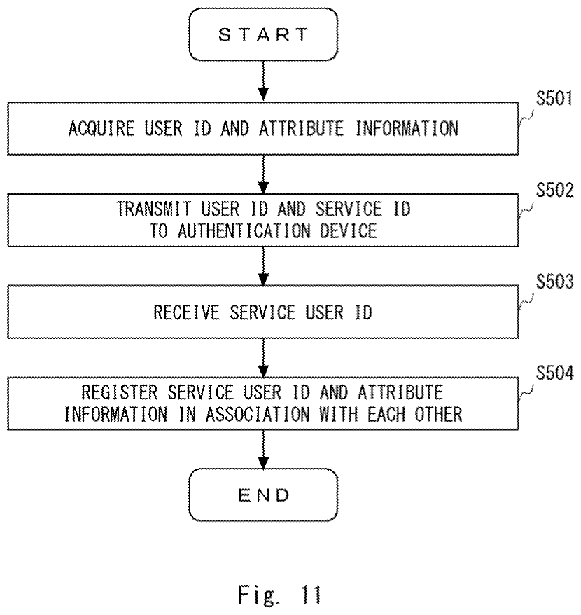

Next, an operation of the service providing device 100a at the time of user registration will be described with reference to FIG. 11. FIG. 11 is a flowchart illustrating a flow of user registration processing. An operation of the service providing device 100a when the user U1 is registered in the storage unit 120 will be described.

The user U1 performs user registration for each service provider. At the time of user registration, the user U1 inputs a user ID and attribute information to an information registration terminal such as the service terminal 300, the user terminal, or the like. Once the input is received, the information registration terminal makes a user registration request to the service providing device 100a via the network 500. The user registration request includes a user ID and attribute information. The registration unit 111 acquires the user ID and attribute information of the user U1 by receiving the user registration request (step S501). Next, the communication unit 140 transmits the user ID and the service ID of the service providing device 100a to the authentication device 200 via the network 500 (step S502). The authentication device 200 transmits a service user ID in response to the reception of the user ID and the service ID. The registration unit 111 receives the service user ID (step S503), and registers the service user ID in the user DB 123 in association with the attribute information (step S504).

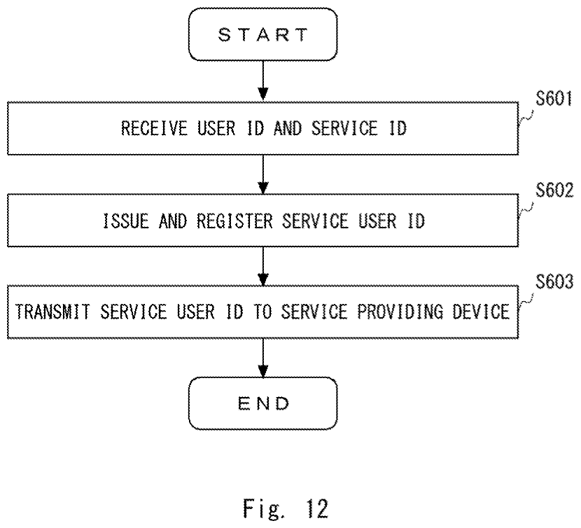

An operation of the authentication device 200 when the user ID and the service ID are received in step S502 will be described with reference to FIG. 12. FIG. 12 is a flowchart illustrating a flow of service user ID generation processing. When the user ID and the service ID are received (step S601), the authentication device 200 newly issues a service user ID 213, and registers the service user ID 213 in the authentication DB 210 in association with the received user ID 211 (step S602). The service registration unit 230 transmits, as a response, the issued service user ID 213 to the service providing device 100a (step S603).

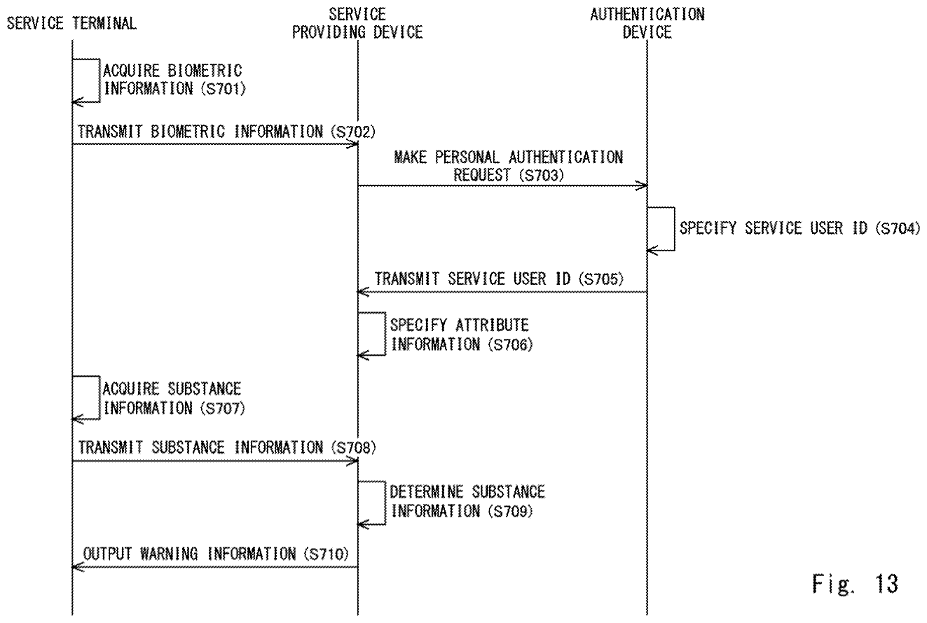

Next, an operation of the warning system 700 at the time of warning processing will be described with reference to FIG. 13. FIG. 13 is a sequence chart illustrating a flow of the warning processing. Note that, at the time of performing the warning processing, it is assumed that a user has performed user registration for the service providing device 100a in advance. First, the service terminal 300 acquires biometric information by extracting the biometric information from a captured image including the biometric information of the user (step S701). Next, the service terminal 300 transmits the acquired biometric information to the service providing device 100a (step S702). Next, the service providing device 100a transmits a personal authentication request including the received biometric information to the authentication device 200 (step S703).

The authentication device 200 performs personal authentication for the received biometric information and specifies a service user ID of the user who has succeeded in the personal authentication (step S704). Next, the authentication device 200 transmits, as a response, a result indicating that the personal authentication has succeeded and the specified service user ID to the service providing device 100a (step S705). The service providing device 100a specifies attribute information associated with the received service user ID (step S706).

Next, the service terminal 300 performs authentication for a product selected by the user and acquires substance information of the product (step S707). Next, the service terminal 300 transmits the specified substance information to the service providing device 100a (step S708). Note that step S707 may be performed in parallel with step S701. In this case, in step S702, the substance information may be transmitted together with the biometric information.

Next, the service providing device 100a determines whether or not the substance information received in step S708 corresponds to the attribute information specified in step S706 (step S709). The service providing device 100a collates the substance information with the attribute information, and determines that the substance information corresponds to the attribute information in a case where there is matching substance information. In a case where the substance information corresponds to the attribute information, the service providing device 100a outputs warning information to the service terminal 300 (step S710). The service terminal 300 presents the received warning information to the user. A timing to present the warning information to the user is usually before the service terminal 300 makes a payment for the product.

Hereinafter, a specific example of a service provided by a service provider to a user and attribute information in the present example embodiment will be described. Specific examples of the service provided by the service provider to the user include “shopping by biometric authentication in a supermarket”. In this case, the service terminal 300 is installed, for example, near a cash register. The user performs biometric authentication through the service terminal 300 at the time of accounting in the cash register. The service providing device 100a acquires substance information of a product that has passed through the cash register, collates the substance information with the attribute information of the user, and outputs warning information as necessary.

Specific examples of the attribute information include “allergy information for the user”. In this case, the substance information is raw material information. The service providing device 100a outputs the warning information in a case where the raw material of the product selected by the user includes an allergy-causing substance for the user. Another specific example of the attribute information includes “information on food that the user cannot eat for religious reasons”. Example of food that the user cannot eat for religious reasons include alcohol-treated food that the user is not allowed to eat because the user is an Islamist. In this case, the substance information is manufacturing information such as a manufacturing process of a product. For example, in a case where alcohol sterilization is performed in a manufacturing process of a product selected by the user, the service providing device 100a outputs warning information.

### Fourth Example Embodiment

A fourth example embodiment is a modification of the third example embodiment described above. In the warning system 700 according to the third example embodiment, the service terminal 300 acquires substance information of a product. On the other hand, in the fourth example embodiment, the service providing device 100a acquires substance information of a product.

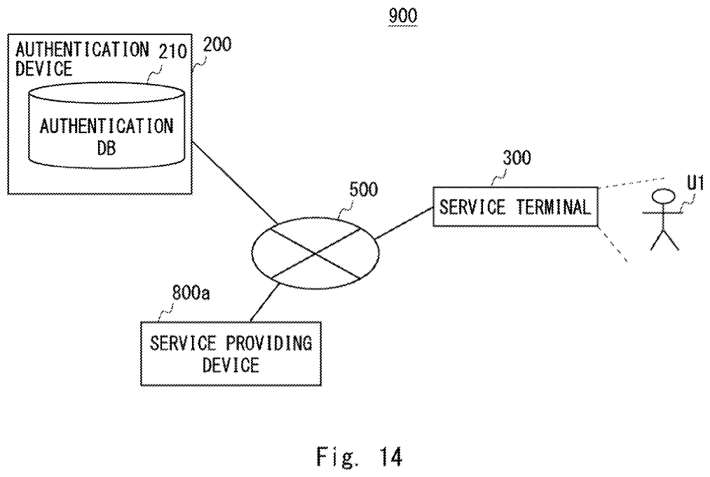

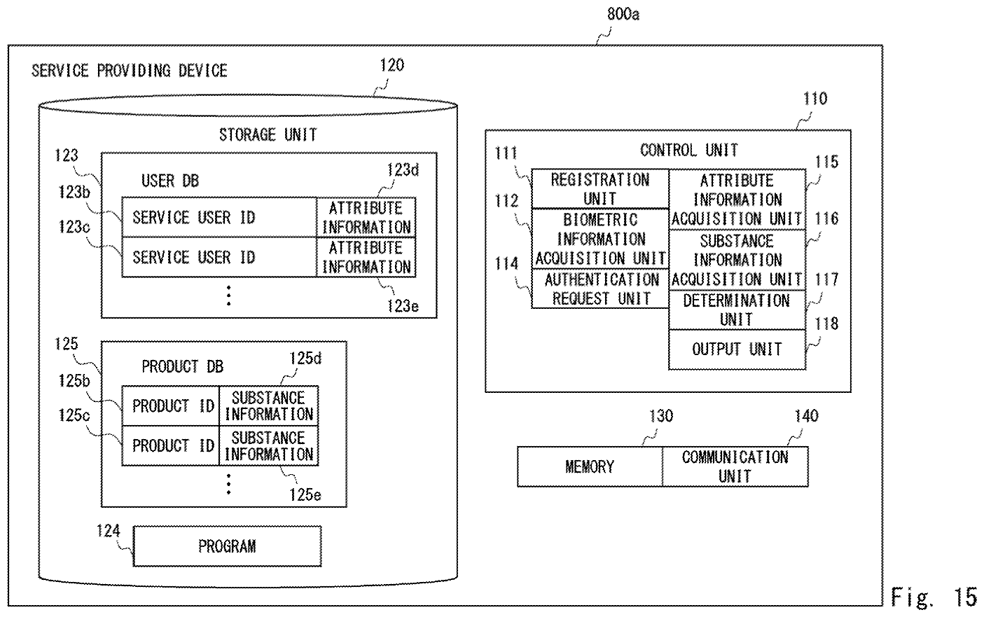

FIG. 14 is a block diagram illustrating a configuration of a warning system 900 according to the fourth example embodiment. The warning system 900 is different from the warning system 700 illustrated in FIG. 5 in that the service providing device 100a is replaced with a service providing device 800a. For each component included in the warning system 900, a description overlapping with that of the third example embodiment will be omitted as appropriate. FIG. 15 is a block diagram illustrating a configuration of the service providing device 800a according to the fourth example embodiment. The service providing device 800a is different from the service providing device 100a in that a storage unit 120 stores a product DB 125, and a substance information acquisition unit 116 specifies substance information associated with a product ID received from a service terminal 300 by referring to the product DB 125. Since the other components are similar, a description thereof will be omitted as appropriate.

The product DB 125 is information in which substance information of a product is associated with a product ID. Product IDs 125b and 125c are pieces of identification information that enable identification of products. The product IDs 125b and 125c are associated with pieces of substance information 125d and 125e, respectively. In the present example embodiment, the product reading unit 353 included in the service terminal 300 performs authentication for a product ID by reading a barcode, an image, or the like. The service terminal 300 transmits the read product ID to the service providing device 100a. The service providing device 100a specifies substance information included in the product by referring to the product DB 125 for the received product ID, and collates the substance information with attribute information.

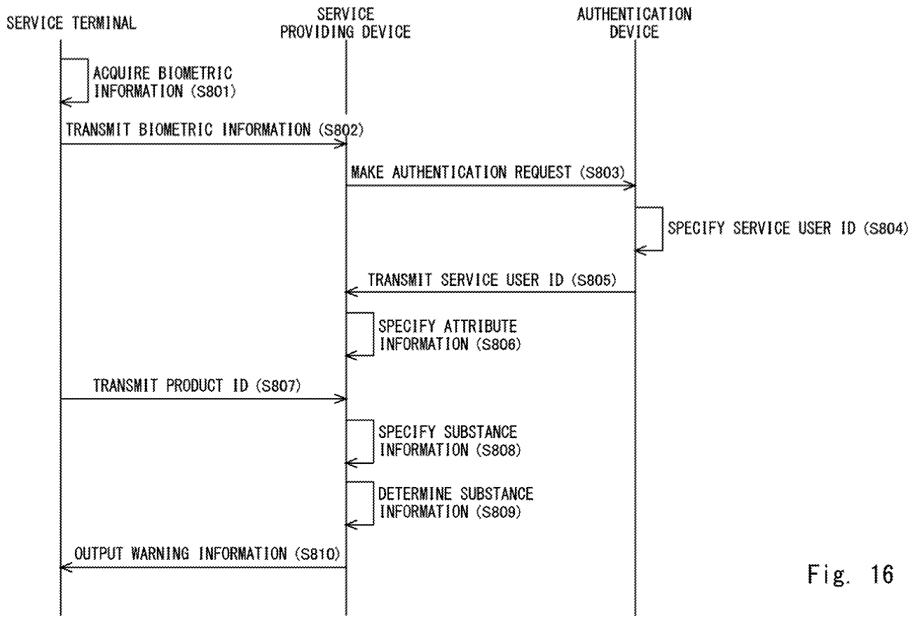

Next, an operation of the warning system 900 at the time of warning processing will be described with reference to FIG. 16. FIG. 16 is a sequence chart illustrating a flow of the warning processing. Note that, at the time of performing the warning processing, it is assumed that a user has performed user registration for the service providing device 800a in advance. First, the service terminal 300 acquires biometric information by extracting the biometric information from a captured image including the biometric information of the user (step S801). Next, the service terminal 300 transmits the acquired biometric information to the service providing device 800a (step S802). Next, the service providing device 800a transmits a personal authentication request including the received biometric information to an authentication device 200 (step S803).

The authentication device 200 performs personal authentication for the received biometric information and specifies a service user ID of the user who has succeeded in the personal authentication (step S804). Next, the authentication device 200 transmits, as a response, a result indicating that the personal authentication has succeeded and the specified service user ID to the service providing device 800a (step S805). The service providing device 800a specifies attribute information associated with the received service user ID (step S806).

Next, the service terminal 300 performs authentication for a product selected by the user, and transmits a product ID of the product to the service providing device 800a (step S807). Next, the service providing device 800a specifies substance information associated with the received product ID (step S808). Note that step S807 may be performed in parallel with step S801. In this case, in step S802, the product ID may be transmitted together with the biometric information.

Next, the service providing device 100a determines whether or not the substance information specified in step S808 corresponds to the attribute information specified in step S806 (step S809). In a case where the substance information corresponds to the attribute information, the service providing device 800a outputs warning information to the service terminal 300 (step S810). The service terminal 300 presents the received warning information to the user.

Hereinafter, a specific example of a service provided by a service provider to a user in the present example embodiment will be described. Specific examples of the service provided by the service provider to the user include “ordering in a restaurant”. In this case, for example, a camera is attached to a communication terminal such as a tablet PC near each guest seat (each table) or for the user to select a menu. An image including biometric information is captured by the camera, and personal authentication is performed based on the image.

Further, a biometric information acquisition terminal may be installed at an entrance of a restaurant, and the service terminal 300 may be installed at each guest seat. The biometric information acquisition terminal is a communication terminal communicable with the service terminal 300, the service providing device 100a, and the like via the network 500, and can capture a captured image including biometric information of a user. In this case, the service terminal 300 does not have to include a camera 310.

When a user enters the restaurant, the biometric information acquisition terminal captures a captured image including biometric information of the user, and presents display such as “please sit on the seat with number 00” to the user. The user sits on the presented guest seat and selects a menu through the service terminal 300 installed at the guest seat. As described above, the biometric information acquisition terminal specifies a user at an entrance or the like and guides the user to a guest seat, so that even in a case where there is no camera in the vicinity of the guest seat and in a tablet PC or the like for selecting a menu, it is possible to grasp on which guest seat the user is seated. The service terminal 300 transmits the selected menu to the service providing device 100a. The biometric information acquisition terminal transmits the captured image and the seat number presented to the user to the service providing device 100a. The service providing device 100a makes a personal authentication request for the captured image. Then, in a case where the menu selected by the user corresponds to attribute information of the user who has succeeded in the authentication, the service providing device 100a outputs warning information to the service terminal 300 installed at the guest seat with the seat number presented to the user. The service providing device 100a discards the attribute information of the user acquired by the attribute information acquisition unit 115 when the payment is completed, when the user leaves the restaurant, or when ordering of the menu ends.

### Fifth Example Embodiment

A fifth example embodiment is a modification of the first to fourth example embodiments described above. In the warning systems 700 and 900 according to the first to fourth example embodiments, a service is provided to one user. On the other hand, in the fifth example embodiment, a service is provided to a group of users.

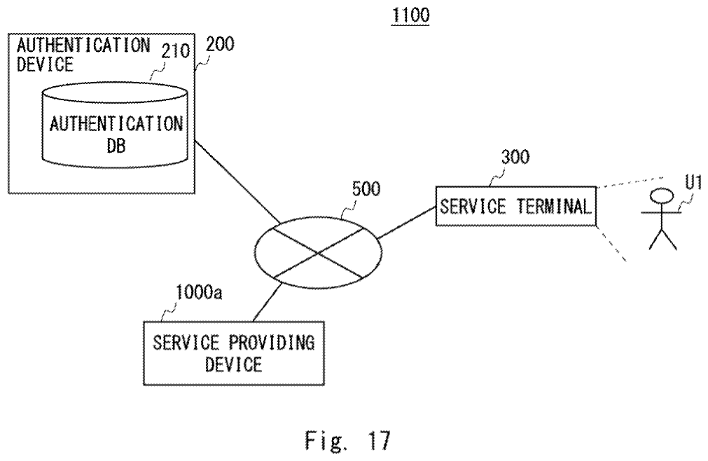

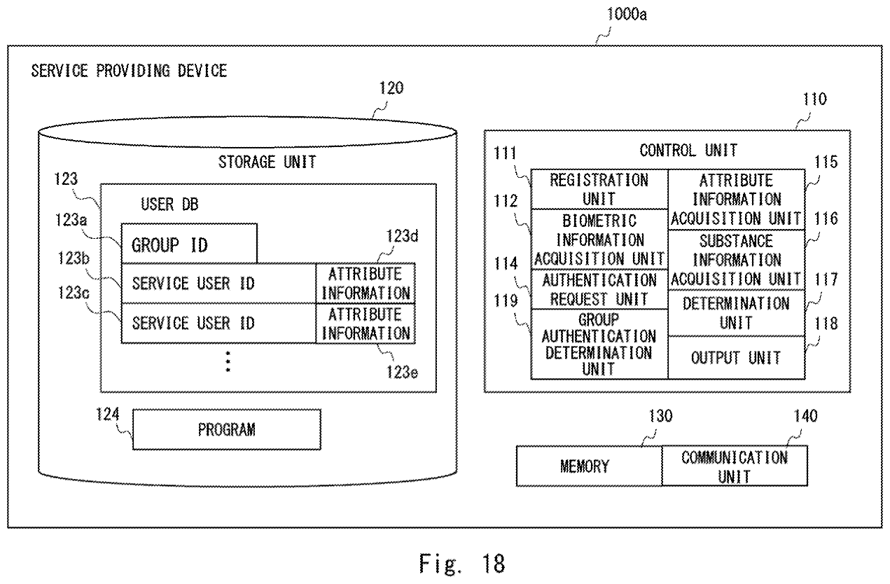

FIG. 17 is a block diagram illustrating a configuration of a warning system 1100 according to the fifth example embodiment. The warning system 1100 is different from the warning system 700 illustrated in FIG. 5 in that the service providing device 100a is replaced with a service providing device 1000a. For each component included in the warning system 1100, a description overlapping with that of the third example embodiment will be omitted as appropriate. FIG. 18 is a block diagram illustrating a configuration of the service providing device 1000a according to the fifth example embodiment. The service providing device 1000a is different from the service providing device 100a in that a user DB 123 recorded in a storage unit 120 includes a group ID 123a and a control unit 110 includes a group authentication determination unit 119. Since the other components are similar, a description thereof will be omitted as appropriate.

A group is an aggregate of a plurality of users. A group ID 123a is identification information that enables identification of the group. In the present example embodiment, the user DB 123 is information in which a user ID of each user included in a group is associated with the group ID 123a. User IDs 123b and 123c are associated with pieces of attribute information 123d and 123e, respectively. That is, the user DB 123 is information in which identification information of a plurality of users belonging to a group and attribute information of each user are associated with group identification information.

In the present example embodiment, group registration for registering each user as a member of a group is performed. The service providing device 1000a has a function of performing group registration processing. When performing the group registration processing, first, the service providing device 1000a individually performs the user registration processing described above according to the operation of each user included in the group. Next, the service providing device 1000a registers a definition of a member included in the group according to an operation of an arbitrary user in the group, and newly issues a group ID.

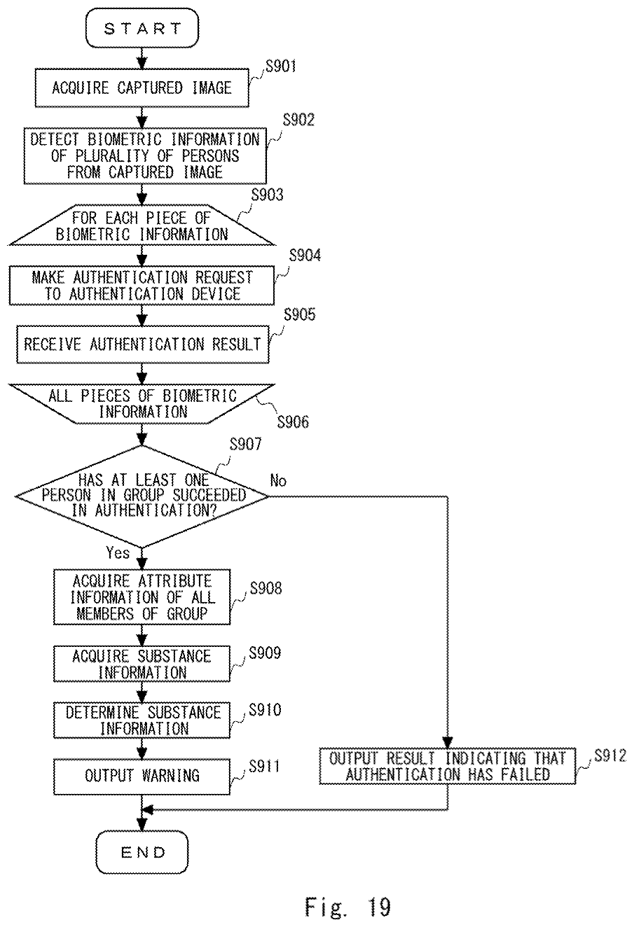

Next, an operation of the service providing device 1000a at the time of warning processing will be described with reference to FIG. 19. FIG. 19 is a flowchart illustrating a flow of the warning processing. Note that, at the time of performing the warning processing, it is assumed that each user included in a group has performed user registration for the service providing device 1000a in advance. First, a biometric information acquisition unit 112 included in the service providing device 1000a acquires a captured image including biometric information of a plurality of users (step S901). Next, the biometric information acquisition unit 112 extracts the biometric information of the plurality of users from the captured image (step S902). Next, the authentication request unit 114 causes the authentication device 200 to perform personal authentication for each pieces of specified biometric information, and receives the personal authentication result (steps S903 to S906).

Here, in the present example embodiment, in a case where the personal authentication has succeeded for at least one piece of extracted biometric information, it is assumed that at least one person in a group has succeeded in the personal authentication. That is, in a case where the personal authentication has failed for all pieces of extracted biometric information, it is assumed that all the members in the group have failed in the personal authentication. In a case where at least one person in the group has succeeded in the personal authentication, the group authentication determination unit 119 determines that the group authentication has succeeded. In a case where at least one person in the group has succeeded in the personal authentication (Yes in step S907), the attribute information acquisition unit 115 specifies a group ID including a service user ID of the user. Next, the attribute information acquisition unit 115 acquires attribute information associated with all service user IDs corresponding to the group ID from the user DB 123 (step S908).

Next, the substance information acquisition unit 116 acquires substance information of a product selected by the user by receiving the substance information from the service terminal 300 (step S909). Next, the determination unit 117 determines whether or not the substance information acquired by the substance information acquisition unit 116 corresponds to the attribute information acquired by the attribute information acquisition unit 115 (step S910). In a case where the substance information corresponds to the attribute information, the output unit 118 outputs warning information to the service terminal 300 (step S911). In addition, in a case where all the members in the group have failed in the personal authentication (No in step S907), the output unit 118 outputs a result indicating that the authentication has failed to the service terminal 300 (step S912).

In the example illustrated in FIG. 19, a case where personal authentication is performed for a plurality of users included in a group has been described. However, in the present example embodiment, the personal authentication may be performed only for any one user in a group. In this case, a captured image including biometric information of one user is acquired in step S901, and in a case where personal authentication for the biometric information has succeeded, the attribute information acquisition unit 115 acquires attribute information of all or some of users in a group to which the user belongs. A case where the members included in the group are a father, a mother, and a child is assumed. For example, in a case where personal authentication is performed only for the mother at the time of payment in a supermarket, the attribute information acquisition unit 115 acquires attribute information such as allergy information for all members in the group (all members of the family). In a case where a product that the mother is about to purchase includes an allergy-causing substance for the child, the output unit 118 outputs a warning to the service terminal 300.

The warning system 1100 according to the present example embodiment can warn a user that raw materials of a menu to be ordered include an allergy-causing substance for a child, for example, when the user has a meal in a restaurant with his/her family. At this time, the personal authentication may be performed only for a guardian such as a father or a mother. Since the service providing device 100a can acquire attribute information (allergy information) of all the members of the family including the child even in a case where the personal authentication is performed only for the guardian, it is possible to output a warning about the allergy information of the child. That is, the personal authentication does not have to be performed for the entire family. Furthermore, the warning system 1100 according to the present example embodiment can achieve effects similar to the effects described in the first to fourth example embodiments.

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following supplementary notes, but are not limited to the following.

### Supplementary Note A1

A warning device including:

a biometric information acquisition unit that acquires biometric information included in a captured image captured by a predetermined imaging device;

an authentication request unit that causes an authentication device that stores biometric information of a plurality of users to perform personal authentication for the acquired biometric information;

an attribute information acquisition unit that acquires attribute information of a user who has succeeded in the personal authentication in a case where the personal authentication has succeeded;

a substance information acquisition unit that acquires substance information included in a product selected by the user;

a determination unit that determines whether or not the substance information corresponds to the attribute information; and

an output unit that outputs warning information to a predetermined display terminal in a case where the substance information corresponds to the attribute information.

### Supplementary Note A2

The warning device according to Supplementary Note A1,

in which in a case where at least one substance included in the substance information corresponds to the attribute information, the determination unit determines that the substance information corresponds to the attribute information.

### Supplementary Note A3

The warning device according to Supplementary Note A1 or A2, in which

the captured image is an image including a face region of the user,

the biometric information is face feature information extracted from the face region, and

the substance information acquisition unit acquires the substance information included in the selected product when a user makes a payment by face authentication.

### Supplementary Note A4

The warning device according to any one of Supplementary Notes A1 to A3, in which

the attribute information acquisition unit acquires attribute information of a user in a group to which the user who has succeeded in the personal authentication belongs, and

the determination unit determines whether or not the substance information corresponds to the acquired attribute information of the user.

### Supplementary Note A5

The warning device according to any one of Supplementary Notes A1 to A4, in which

the captured image includes biometric information of a plurality of persons,

the authentication request unit causes the authentication device to perform personal authentication for the biometric information of each of the plurality of persons detected from the captured image,

the warning device further includes a group authentication determination unit that determines that group authentication has succeeded in a case where personal authentication for biometric information of at least one of a plurality of users registered as a group using the detected biometric information of the plurality of persons has succeeded,

the substance information acquisition unit acquires attribute information of all the users belonging to the group for which the group authentication has succeeded, and

the determination unit determines whether or not the substance information corresponds to the acquired attribute information of all the users.

### Supplementary Note A6

The warning device according to any one of Supplementary Notes A1 to A5, in which

the attribute information is allergy information of the user, and

the substance information is raw material information of the product.

### Supplementary Note A7

The warning device according to any one of Supplementary Notes A1 to A6, in which

the attribute information is information of food that is not eatable by the user, and

the substance information is manufacturing information of the product.

### Supplementary Note A8

The warning device according to any one of Supplementary Notes A1 to A7, in which

the predetermined imaging device is installed near a cash register of a store, and

the substance information acquisition unit acquires substance information of a product that has passed through the cash register.

### Supplementary Note A9

The warning device according to any one of Supplementary Notes A1 to A7, in which

the predetermined imaging device is installed near an entrance of a store, and

the substance information acquisition unit acquires substance information included in a product input through a service terminal installed at a guest seat.

### Supplementary Note B1

A warning system including:

an imaging device that captures an image including biometric information of a predetermined user;

a warning device that is communicable with the imaging device; and

an authentication device that stores the biometric information of the user and is communicable with the warning device,

in which the warning device includes:

a biometric information acquisition unit that acquires biometric information included in a captured image captured by the imaging device;

an authentication request unit that causes the authentication device to perform personal authentication for the acquired biometric information;

an attribute information acquisition unit that acquires attribute information of a user who has succeeded in the personal authentication in a case where the personal authentication has succeeded;

a substance information acquisition unit that acquires substance information included in a product selected by the user;

a determination unit that determines whether or not the substance information corresponds to the attribute information; and

an output unit that outputs warning information to a predetermined display terminal in a case where the substance information corresponds to the attribute information.

### Supplementary Note B2

The warning system according to Supplementary Note B1,

in which in a case where at least one substance included in the substance information corresponds to the attribute information, the determination unit determines that the substance information corresponds to the attribute information.

### Supplementary Note C1

A warning method performed by a computer, the warning method including:

acquiring biometric information included in a captured image captured by a predetermined imaging device;

causing an authentication device that stores biometric information of a plurality of users to perform personal authentication for the acquired biometric information;

acquiring attribute information of a user who has succeeded in the personal authentication in a case where the personal authentication has succeeded;

acquiring substance information included in a product selected by the user;

determining whether or not the substance information corresponds to the attribute information; and

outputting warning information to a predetermined display terminal in a case where the substance information corresponds to the attribute information.

### Supplementary Note D1

A non-transitory computer-readable medium storing a warning program that causes a computer to perform:

acquiring biometric information included in a captured image captured by a predetermined imaging device;

causing an authentication device that stores biometric information of a plurality of users to perform personal authentication for the acquired biometric information;

acquiring attribute information of a user who has succeeded in the personal authentication in a case where the personal authentication has succeeded;

acquiring substance information included in a product selected by the user;

determining whether or not the substance information corresponds to the attribute information; and

outputting warning information to a predetermined display terminal in a case where the substance information corresponds to the attribute information.

### Supplementary Note E1

A warning device including:

a biometric information acquisition unit that acquires biometric information included in a captured image captured by a predetermined imaging device;

a personal authentication that performs personal authentication by using biometric information of a plurality of users stored in advance for the acquired biometric information;

an attribute information acquisition unit that acquires attribute information of a user who has succeeded in the personal authentication in a case where the personal authentication has succeeded;

a substance information acquisition unit that acquires substance information included in a product selected by the user;

a determination unit that determines whether or not the substance information corresponds to the attribute information; and

an output unit that outputs warning information to a predetermined display terminal in a case where the substance information corresponds to the attribute information.

### Supplementary Note E2

The warning device according to Supplementary Note E1,

in which in a case where at least one substance included in the substance information corresponds to the attribute information, the determination unit determines that the substance information corresponds to the attribute information.

### Supplementary Note F1

A warning method performed by a computer, the warning method including:

acquiring biometric information included in a captured image captured by a predetermined imaging device;

performing personal authentication by using biometric information of a plurality of users stored in advance for the acquired biometric information;

acquiring attribute information of a user who has succeeded in the personal authentication in a case where the personal authentication has succeeded;

acquiring substance information included in a product selected by the user;

determining whether or not the substance information corresponds to the attribute information; and

outputting warning information to a predetermined display terminal in a case where the substance information corresponds to the attribute information.

### Supplementary Note G1

A non-transitory computer-readable medium storing a warning program that causes a computer to perform:

acquiring biometric information included in a captured image captured by a predetermined imaging device;

performing personal authentication by using biometric information of a plurality of users stored in advance for the acquired biometric information;

acquiring attribute information of a user who has succeeded in the personal authentication in a case where the personal authentication has succeeded;

acquiring substance information included in a product selected by the user;

determining whether or not the substance information corresponds to the attribute information; and

outputting warning information to a predetermined display terminal in a case where the substance information corresponds to the attribute information.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### REFERENCE SIGNS LIST

100, 600 WARNING DEVICE
100a, 800a, 1000a SERVICE PROVIDING DEVICE
700, 900, 1100 WARNING SYSTEM
110 CONTROL UNIT
111 REGISTRATION UNIT
112 BIOMETRIC INFORMATION ACQUISITION UNIT
114 AUTHENTICATION REQUEST UNIT
115 ATTRIBUTE INFORMATION ACQUISITION UNIT
116 SUBSTANCE INFORMATION ACQUISITION UNIT
117 DETERMINATION UNIT
118 OUTPUT UNIT
119 GROUP AUTHENTICATION DETERMINATION UNIT
120 STORAGE UNIT
121 PERSONAL AUTHENTICATION UNIT
123 USER DB
123a GROUP ID
123b, 123c SERVICE USER ID
123d, 123e ATTRIBUTE INFORMATION
124 PROGRAM
125 PRODUCT DB
125b, 125c PRODUCT ID
125d, 125e SUBSTANCE INFORMATION
130 MEMORY
140 COMMUNICATION UNIT
200 AUTHENTICATION DEVICE
210 AUTHENTICATION DB
211 USER ID
212 SERVICE ID
213 SERVICE USER ID
214 BIOMETRIC INFORMATION
220 USER REGISTRATION UNIT
230 SERVICE REGISTRATION UNIT
240 AUTHENTICATION UNIT
300 SERVICE TERMINAL
310 CAMERA
320 STORAGE UNIT
330 COMMUNICATION UNIT
340 DISPLAY UNIT
350 CONTROL UNIT
352 IMAGE ACQUISITION UNIT
353 PRODUCT AUTHENTICATION UNIT
354 SUBSTANCE INFORMATION ACQUISITION UNIT
355 PAYMENT UNIT
500 NETWORK

What is claimed is:

1. A warning device comprising:
at least one memory acquiring storing instructions and
at least one processor configured to execute the instructions to;
acquire biometric information included in a captured image captured by a predetermined imaging device;
cause an authentication device that stores biometric information of a plurality of users to perform personal authentication for the acquired biometric information;
acquire attribute information of a user who has succeeded in the personal authentication in a case where the personal authentication has succeeded;
acquire substance information included in a product selected by the user;
determine whether or not the substance information corresponds to the attribute information; and
output warning information to a predetermined display terminal in a case where the substance information corresponds to the attribute information.

2. The warning device according to claim 1,
wherein in a case where at least one substance included in the substance information corresponds to the attribute information, the at least one processor is further configured to execute the instructions to determine that the substance information corresponds to the attribute information.

3. The warning device according to claim 1, wherein
the captured image is an image including a face region of the user,
the biometric information is face feature information extracted from the face region, and
the at least one processor is further configured to execute the instructions to acquire the substance information included in the selected product when a user makes a payment by face authentication.

4. The warning device according to claim 1, wherein the at least one processor is further configured to execute the instructions to;
acquire attribute information of a user in a group to which the user who has succeeded in the personal authentication belongs, and
determine whether or not the substance information corresponds to the acquired attribute information of the user.

5. The warning device according to claim 1, wherein
the captured image includes biometric information of a plurality of persons,
the at least one processor is further configured to execute the instructions to;
cause the authentication device to perform personal authentication for the biometric information of each of the plurality of persons detected from the captured image,
determine that group authentication has succeeded in a case where personal authentication for biometric information of at least one of a plurality of users registered as a group using the detected biometric information of the plurality of persons has succeeded,
acquire attribute information of all the users belonging to the group for which the group authentication has succeeded, and
determine whether or not the substance information corresponds to the acquired attribute information of all the users.

6. The warning device according to claim 1, wherein
the attribute information is allergy information of the user, and
the substance information is raw material information of the product.

7. The warning device according to claim 1, wherein
the attribute information is information of food that is not eatable by the user, and
the substance information is manufacturing information of the product.

8. The warning device according to claim 1, wherein
the predetermined imaging device is installed near a cash register of a store, and
the at least one processor is further configured to execute the instructions to acquire substance information of a product that has passed through the cash register.

9. The warning device according to claim 1, wherein
the predetermined imaging device is installed near an entrance of a store, and
the at least one processor is further configured to execute the instructions to acquire substance information included in a product input through a service terminal installed at a guest seat.

10. A warning system comprising:
an imaging device that captures an image including biometric information of a predetermined user;
a warning device that is communicable with the imaging device; and
an authentication device that stores the biometric information of the user and is communicable with the warning device,
wherein the warning device is configured to:
acquire biometric information included in a captured image captured by the imaging device;
cause the authentication device to perform personal authentication for the acquired biometric information;
acquire attribute information of a user who has succeeded in the personal authentication in a case where the personal authentication has succeeded;
acquire substance information included in a product selected by the user;
determine whether or not the substance information corresponds to the attribute information; and
output warning information to a predetermined display terminal in a case where the substance information corresponds to the attribute information.

11. The warning system according to claim 10,
wherein in a case where at least one substance included in the substance information corresponds to the attribute information, the warning device is configured to determine that the substance information corresponds to the attribute information.

12. A warning method performed by a computer, the warning method comprising:
acquiring biometric information included in a captured image captured by a predetermined imaging device;
causing an authentication device that stores biometric information of a plurality of users to perform personal authentication for the acquired biometric information;
acquiring attribute information of a user who has succeeded in the personal authentication in a case where the personal authentication has succeeded;
acquiring substance information included in a product selected by the user;
determining whether or not the substance information corresponds to the attribute information; and
outputting warning information to a predetermined display terminal in a case where the substance information corresponds to the attribute information.

13. A non-transitory computer-readable medium storing a warning program that causes a computer to perform:
acquiring biometric information included in a captured image captured by a predetermined imaging device;
causing an authentication device that stores biometric information of a plurality of users to perform personal authentication for the acquired biometric information;
acquiring attribute information of a user who has succeeded in the personal authentication in a case where the personal authentication has succeeded;
acquiring substance information included in a product selected by the user;
determining whether or not the substance information corresponds to the attribute information; and
outputting warning information to a predetermined display terminal in a case where the substance information corresponds to the attribute information.

14. A warning device comprising:
at least one memory acquiring storing instructions and at least one processor configured to execute the instructions to;
acquire biometric information included in a captured image captured by a predetermined imaging device;
perform personal authentication by using biometric information of a plurality of users stored in advance for the acquired biometric information;
acquire attribute information of a user who has succeeded in the personal authentication in a case where the personal authentication has succeeded;
acquire substance information included in a product selected by the user;
determine whether or not the substance information corresponds to the attribute information; and
output warning information to a predetermined display terminal in a case where the substance information corresponds to the attribute information.

15. The warning device according to claim 14,
wherein in a case where at least one substance included in the substance information corresponds to the attribute information, the at least one processor is further configured to execute the instructions to determine that the substance information corresponds to the attribute information.

16. A warning method performed by a computer, the warning method comprising:
acquiring biometric information included in a captured image captured by a predetermined imaging device;
performing personal authentication by using biometric information of a plurality of users stored in advance for the acquired biometric information;
acquiring attribute information of a user who has succeeded in the personal authentication in a case where the personal authentication has succeeded;
acquiring substance information included in a product selected by the user;
determining whether or not the substance information corresponds to the attribute information; and
outputting warning information to a predetermined display terminal in a case where the substance information corresponds to the attribute information.

17. A non-transitory computer-readable medium storing a warning program that causes a computer to perform:
acquiring biometric information included in a captured image captured by a predetermined imaging device;
performing personal authentication by using biometric information of a plurality of users stored in advance for the acquired biometric information;
acquiring attribute information of a user who has succeeded in the personal authentication in a case where the personal authentication has succeeded;
acquiring substance information included in a product selected by the user;
